(19) United States
(12) Patent Application Publication
(10) Pub. No.: US 2006/0108909 A1
(43) Pub. Date: May 25, 2006

(54) Color cathode ray tube and electron gun used therein

(75) Inventor: Kazunori Sato, Ibaraki-shi (JP)

Correspondence Address: HAMRE, SCHUMANN, MUELLER & LARSON, P.C., P.O. BOX 2902-0902, MINNEAPOLIS, MN, 55402, US

(73) Assignee: Matsushita Toshiba Picture Display Co., Ltd., Takatsuki-shi (JP)

(21) Appl. No.: 11/287,069

(22) Filed: Nov. 23, 2005

(30) Foreign Application Priority Data
Nov. 25, 2004 (JP) 2004-341052

(51) Int. Cl. H01J 29/50

(52) U.S. Cl. 313/414

(57) ABSTRACT

A focusing electrode includes an electric field correcting electrode, and a peripheral electrode in which one electron beam passage aperture is formed on a surface opposed to a final-stage accelerating electrode. The final-stage accelerating electrode includes an electric field correcting electrode, and a peripheral electrode in which one electron beam passage aperture is formed on a surface opposed to the focusing electrode. In the focusing electrode, assuming that a distance from an end on the final-stage accelerating electrode side of the peripheral electrode to the electric field correcting electrode is L1, horizontal and vertical dimensions of the electron beam passage aperture of the peripheral electrode are H1, V1, and in the final-stage accelerating electrode, assuming that a distance from an end on the focusing electrode side of the peripheral electrode to the electric field correcting electrode is L2, and horizontal and vertical dimensions of the electron beam passage aperture of the peripheral electrode are H2, V2, relationships: L1<L2 and V1/H1>V2/H2 are satisfied. Because of this, the occurrence of a coma aberration of a side electron beam and the degradation in convergence are suppressed, and the dimension of a beam spot on a phosphor screen can be decreased.

### BACKGROUND OF THE INVENTION

1. Field of the Invention

The present invention relates to a color cathode ray tube and an electron gun used therein. In particular, the present invention relates to an in-line type electron gun that enhances the resolution on a phosphor screen, and a color cathode ray tube with the in-line type electron gun mounted therein.

2. Description of Related Art

In general, as shown in FIG. 10, a color cathode ray tube includes an envelope composed of a panel 1 and a funnel 2 that is integrally connected to the panel 1. On an inner surface of the panel 1, a phosphor screen 3 composed of stripe-shaped or dot-shaped phosphor layers of three colors emitting blue, green, and red light is formed, and a shadow mask 4 with a number of electron beam passage apertures formed thereon is provided so as to be opposed to the phosphor screen 3. An electron gun 7 emitting three electron beams 6B, 6G, 6R is provided in a neck 5 of the funnel 2.

Such a color cathode ray tube and a deflection apparatus 8 mounted on an outer side of the funnel 2 constitute a color cathode ray tube apparatus. The electron beams 6B, 6G, 6R emitted from the electron gun 7 are deflected by a horizontal deflection magnetic field and a vertical deflection magnetic field generated by the deflection apparatus 8, and scan the phosphor screen 3 via the shadow mask 4 in horizontal and vertical directions, whereby a color image is displayed.

In the above-mentioned color cathode ray tube apparatus, particularly, a self-convergence-in-line type color cathode ray tube is the mainstream of a current color cathode ray tube. The self-convergence in-line type color cathode ray tube has the following configuration: an in-line type electron gun emitting the three electron beams 6B, 6G, 6R with 6G as a center beam and 6B, 6R as a pair of side beams on both outer sides thereof, aligned on the same horizontal plane, is used as the electron gun 7, and the horizontal deflection magnetic field and the vertical deflection magnetic field generated by the deflection apparatus 8 are set to be a pin-cushion type and a barrel type, respectively, whereby the above-mentioned three electron beams 6B, 6G, 6R on the same horizontal plane are converged over an entire surface of the phosphor screen 3 by a non-uniform magnetic field.

In this self-convergence-in-line type color cathode ray tube, regarding the deflection magnetic field, the horizontal deflection magnetic field is set to be a pin-cushion type and the vertical deflection magnetic field is set to be a barrel type, as described above. Therefore, as a deflection angle increases, the function as a quadrupole lens of focusing the electron beams in a vertical direction and diverging them in a horizontal direction is enhanced equivalently.

Consequently, beam spots on the phosphor screen 3 are formed as shown in FIG. 11. More specifically, a beam spot in a center portion of the phosphor screen 3 becomes a perfect circle, and each beam spot in a peripheral portion of the phosphor screen 3 involves a halo 10, which is an over-focused component, on upper and lower sides of the spot in the vertical direction, with the result that a resolution is degraded remarkably.

In order to solve the above-mentioned problem, a method has been used widely, for focusing the electron beams more strongly in the vertical direction than in the horizontal direction with a pre-focus lens part in the electron gun 7, and allowing the electron beams with a cross-section in a horizontally oriented shape to be incident upon the deflection yoke 8, thereby reducing an aberration caused by the deflection magnetic field.

FIG. 12 shows a bipotential electron gun as an example of such an electron gun. This electron gun includes three cathodes K arranged in a line in the horizontal direction, three heaters (not shown) heating the cathodes K separately, and a first grid G1, a second grid G2, a third grid G3, and a fourth grid. G4 arranged successively from the cathodes K side, and these components are fixed integrally by a pair of insulating supports (not shown).

Among the above-mentioned grids, the first grid G1 and the second grid G2 have a plate shape, and on each plate surface, three substantially circular electron beam passage apertures are formed so as to correspond to the above-mentioned three cathodes K arranged in a line.

The third grid G3 is composed of a tubular electrode. On a surface of the third grid G3 opposed to the second grid G2, three vertically oriented electron beam passage apertures are provided in a straight line in the horizontal direction, and on a surface of the third grid G3 opposed to the fourth grid G4, three substantially circular electron beam passage apertures are provided in a straight line in the horizontal direction.

The fourth grid G4 is composed of a tubular electrode, and on both end surfaces thereof, three substantially circular electron beam passage apertures are provided in a straight line in the horizontal direction.

In this electron gun, the cathodes K are supplied with a voltage of 50 to 200 V. The first grid G1 is grounded. The second grid G2 is supplied with a voltage of 300 to 1000 V The third grid G3 is supplied with a voltage of about 6 kV to 10 kV, which is at a relatively intermediate level. The fourth grid G4 is supplied with a voltage of about 25 kV to 35 kV, which is at a relatively high level.

This electron gun is applied to an in-line type color cathode ray tube, and each electrode is supplied with the above-mentioned voltage. Accordingly, a tripolar part (electron beam generating part) generating three electron beams composed of a center beam and a pair of side beams aligned in an in-line shape on the same horizontal plane is constituted by the cathodes K, the first grid G1, and the second grid G2; a pre-focus lens part preliminarily focusing the three electron beams released from the tripolar part is formed between the second grid G2 and the third grid G3; and a main lens part accelerating the three preliminarily focused electron beams and focusing them on the phosphor screen is constituted by the third grid G3 and the fourth grid G4.

In general, the size of an aperture of a main lens in an electron gun is one of the factors greatly influencing the focus characteristics of a color cathode ray tube. When the aperture of the main lens is enlarged, the magnification and aberration of the main lens with respect to the electron beams decrease, whereby a small beam spot can be obtained on the phosphor screen.

Examples of a method for enlarging the aperture of the main lens include enlarging electron beam passage apertures of two electrodes forming the main lens and enlarging the distance between the two electrodes forming the main lens.

Table 1 shows calculated results in which the aperture of the main lens, which is formed in the case where a dimension D of each of the electron beam passage apertures formed on the surface of the third grid G3 opposed to the fourth grid G4 and on the surface of the fourth grid G4 opposed to the third grid G3 is set to be constant (Φ5.0 mm) and an interelectrode distance L between the third grid G3 and the fourth grid G4 is varied, is represented as a relative ratio with the aperture of the main lens formed at L=1.0 mm being 1.

TABLE 1

| Interelectrode distance L | Aperture of main lens |
|---|---|
| (mm) | (relative ratio) |
| 1.0 | 1.0 |
| 3.0 | 1.24 |
| 5.0 | 1.38 |

The following is understood from Table 1. If the dimension D of the electron beam passage apertures is the same, as the interelectrode distance L increases, the aperture of the main lens becomes larger.

In an actual in-line type color cathode ray tube, since the electron gun 7 is placed in the neck 5 with an inner diameter limited, there is an upper limit to the size in an in-line direction (i.e., horizontal direction) of the three cathodes K arranged in an in-line shape and the electrodes, and there also is an upper limit to the dimension D of the electron beam passage apertures formed in the electrodes constituting the main lens. Therefore, in order to enlarge the aperture of the main lens, it is necessary to enlarge the interelectrode distance L between the electrodes constituting the main lens. However, in the case where the interelectrode distance L is enlarged, the influence of the potential of a neck inner wall cannot be ignored. In order to form an appropriate main lens, it is necessary to suppress the interelectrode distance L to 1.5 mm or less. Thus, it is difficult to enlarge the aperture of the main lens substantially.

As a procedure for enlarging the aperture of the main lens, an electric field superimposing type main lens, in which a lens common to three electron beams is formed, is known (e.g., see JP 7(1995)-182991 A). FIG. 13 shows an electron gun using the electric field superimposing type main lens. The same constituent components as those in FIG. 12 are denoted with the same reference numerals as those therein, and the description thereof will be omitted here. In the same way as in a conventional electron gun, the electric field superimposing type main lens is composed of the third grid G3 supplied with a voltage of about 6 kV to 10 kV, which is at a relatively intermediate level, and the fourth grid G4 supplied with a voltage of about 25 kV to 35 kV, which is at a relatively high level. In this electron gun, on the fourth grid G4 side of the third grid G3 and the third grid G3 side of the fourth grid G4, tubular peripheral electrodes 33, 34 having an oval end face shown in FIG. 14 are placed, and the peripheral electrodes 33, 34 form a lens common to the three electron beams. Furthermore, in the grid G3, a plate-shaped electric field correcting electrode 23 is placed at a position with a distance L3 from an end on the fourth grid G4 side of the peripheral electrode 33, and in the fourth grid G4, a plate-shaped electric field correcting electrode 24 is placed at a position with a distance L4 from an end on the third grid G3 side of the peripheral electrode 34. The distances L3, L4 from the end faces of the peripheral electrodes 33, 34 to the electric field correcting electrodes 23, 24 are substantially equal to each other. Furthermore, the electric field correcting electrodes 23, 24 have the same shape, and have three substantially circular electron beam passage apertures 70, as shown in FIG. 15. The electric field correcting electrodes 23, 24 have the effect of shaping and optimizing a lens common to the three electron beams formed between the third grid G3 and the fourth grid G4 for each electron beam.

In the same way as in the electron gun shown in FIG. 12, the aperture of the electric field superimposing type main lens greatly depends upon the dimension of the electron beam passage apertures 70 provided in the respective electric field correcting electrodes 23, 24, and a distance L′ between the electric field correcting electrodes 23, 24. However, the influence of the potential of a neck inner wall is suppressed by the peripheral electrodes 33, 34, so that it is possible to enlarge the distance L′ between the electric field correcting electrodes greatly compared with the interelectrode distance L in the electron gun in FIG. 12. Because of this, the aperture of the electric field superimposing type main lens can be enlarged more than that of a conventional lens, so that the electric field superimposing type main lens currently has been adopted for a number of electron guns.

However, in the above-mentioned electric field superimposing type main lens, there is a problem that a coma aberration in the horizontal direction occurs in side beams due to the influence of the peripheral electrodes 33, 34. The reason for this will be described with reference to FIG. 16. FIG. 16 is an enlarged view of a main lens part of the electron gun using the electric field superimposing type main lens shown in FIG. 13. A side beam is incident upon the electric field superimposing type main lens with a point Os being an output point. A side beam center path 60 is set so as to arrive at an intersection P between an electron gun center axis (matched with a center beam center path) 63 and the phosphor screen 3, and pass through the center of a side beam passage aperture provided in the electric field correcting electrode 23 of the third grid G3, when the main lens does not function.

Furthermore, a chain double-dashed line 62 represents a side beam inside path, which is the path of an electron output at an angle α on the center beam side in the in-line direction with respect to the side beam center path 60 with the point Os being an output point. Furthermore, a broken line 61 represents a side beam outside path, which is the path of an electron output at the angle α on a side opposite to the center beam in the in-line direction with respect to the side beam center path 60 with the point Os being an output point.

In the electric field superimposing type main lens, the peripheral electrodes 33, 34 are present. Therefore, in the in-line direction, the penetration of an electric field 50 to a region between the electric field correcting electrodes 23, 24 decreases with a distance from the electron gun center axis 63, so that the focusing function increases.

Thus, the focusing force exerted by the main lens varies between the inside and the outside of a side beam. The intersection position between the side beam outside path 61 and the side beam center path 60 is not matched with the intersection position between the side beam inside path 62 and the side beam center path 60, and placed on the cathode side with respect to the intersection position between the side beam inside path 62 and the side beam center path 60. Accordingly, in the center portion of the phosphor screen 3, a distance C between an arrival point Q0 of the side beam center path 60 and an arrival point Q1 of the side beam outside path 61 is different from a distance B between the arrival point Q0 of the side beam center path and an arrival point Q2 of the side beam inside path 62 (C>B), and an electron beam spot is distorted, with the result that a coma aberration occurs.

As a procedure for suppressing the coma aberration, generally, the following is considered.

I. A horizontal dimension H of each aperture of the peripheral electrodes 33, 34 is enlarged.

II. The center of each side beam passage aperture of the electric field correcting electrodes 23, 24 is deflected with respect to the side beam center path 60.

III. The distances L3, L4 from the end faces of the peripheral electrodes 33, 34 to the electric field correcting electrodes 23, 24 are changed.

However, regarding I, such an enlargement is limited by the inner diameter of the neck 5.

Regarding II, the center of the side beam passage aperture may be deflected outward with respect to the side beam center path 60 passing through the side beam passage aperture. Herein, in FIG. 16, it is assumed that the electric field correcting electrodes 23, 24 have the same shape, the dimension of all the electron beam passage apertures is Φ4.8 mm, a distance sg from the electron gun center axis 63 to the center of the side beam passage aperture is 5.7 mm, and the distance L′ between the electric field correcting electrodes 23, 24 is 9.0 mm. It is assumed that the peripheral electrodes 33, 34 have the same shape, the horizontal dimension H of the apertures on the sides opposed to each other is 19.2 mm, and a vertical dimension V thereof is 9.0 mm (see FIG. 14). It is assumed that both the distances L3, L4 from the end faces of the peripheral electrodes 33, 34 to the electric field correcting electrodes 23, 24 are 4.0 mm. It is assumed that the voltage applied to the third grid G3 is 28% of the voltage applied to the fourth grid G4. Furthermore, in the center portion of the phosphor screen 3, a distance between the arrival point P of the center beam center path (i.e., the electron gun center axis) 63 and the arrival point Q0 of the side beam center path 60 is represented by A.

FIG. 17 shows results obtained by calculating a change in a coma aberration when the distance sg from the electron gun center axis 63 to the center of the side beam passage aperture is increased from 5.7 mm under the above-mentioned conditions. Herein, the coma aberration corresponds to a difference (C-B) between the distances B and C described with reference to FIG. 16.

In FIG. 17, when sg is 5.7 mm, although the side beam center path 60 passes through the center of the side beam passage aperture of the electric field correcting electrode 23 of the third grid G3, a coma aberration occurs. This shows that the focusing force exerted by the main lens varies between the inside (on the electron gun center axis 63 side) of the side beam and the outside (on a side opposite to the electron gun center axis 63) of the side beam. Herein, the following is understood. When the center of each side beam passage aperture of the electric field correcting electrodes 23, 24 is moved outward (i.e., sg is increased) with the output point Os and the output angle of the side beam being fixed, the coma aberration gradually decreases, and is eliminated when sg is 6.7 mm. That is, if the center of each side beam passage aperture of the electric field correcting electrodes 23, 24 is moved outward with respect to the side beam center path 60, the coma aberration can be decreased.

However, according to the above procedure, as shown in FIG. 18, a distance X2 between the side beam center path 60 and an inner edge of the side beam passage aperture becomes small, and the lens aperture with respect to a side beam becomes small. In the above example, the dimension of the side beam passage aperture is Φ4.8 mm, the distance sg from the electron gun center axis 63 to the center of the side beam passage aperture of the electric field correcting electrode 23 of the third grid G3 is 6.7 mm, and the distance from the electron gun center axis 63 to the side beam center path 60 when the side beam center path 60 passes through the electric field correcting electrode 23 is 5.7 mm. Therefore, the distance X2 between the side beam center path 60 and the inner edge of the side beam passage aperture of the electric field correcting electrode 23 is 1.4 mm, while a distance X3 between the side beam center path 60 and the outer edge of the side beam passage aperture of the electric field correcting electrode 23 is 3.4 mm. Thus, the distance X2 between the side beam center path 60 and the inner edge of the side beam passage aperture is remarkably short. In the case where the lens aperture with respect to a side beam is shortened, it is necessary that the lens aperture with respect to a center beam also is shortened, and a horizontal radius X1 of the center beam passage aperture of the electric field correcting electrodes 23, 24 needs to be decreased to a degree equal to that of the distance X2. Consequently, the electric field correcting electrodes 23, 24 have aperture shapes as shown in FIG. 18, and electron beams are likely to strike both edges in the horizontal direction of the center beam passage aperture and the inner edge of the side beam passage aperture. Alternatively, in order to correct a coma aberration, as shown in FIG. 19, there also is a method for enlarging the dimension of the side beam passage apertures of the electric field correcting electrodes 23, 24, which has been adopted currently in a number of electron guns. According to this method, the distance X2 with respect to the side beam passage aperture and the horizontal radius X1 of the center beam passage aperture are slightly enlarged. The dimension of electron beams becomes maximum immediately before the incidence upon the main lens, so that the electron beams still are likely to strike the electric field correcting electrode 23 of the third grid G3. When the electron beams strike the electrode, the electric potential becomes unstable, and a discharge as well as focus degradation are caused, which may cause the breakdown of a TV set.

In order to prevent the electron beams from striking the electric field correcting electrode 23, the electron beams may be focused sufficiently before being incident upon the main lens. However, when the electron beams are focused immediately before being incident upon the main lens, the beam dimension on the phosphor screen 3 is degraded. Consequently, even if a main lens with a large aperture is formed, the dimension of a beam spot cannot be decreased to such a degree as to be consistent with the enlargement of the lens aperture.

Regarding III, a relationship between the distances L3, L4 from the end faces of the peripheral electrodes 33, 34 to the electric field correcting electrodes 23, 24 and the coma aberration was studied. With the conditions such as the dimension of each aperture of the electric field correcting electrodes 23, 24, applied voltages, and the like being the same as those in the case of studying the above II, the distances L3, L4 were changed. FIG. 20 shows results obtained by calculating a change in a coma aberration (C-B) when L3/L4 is changed while the distance L′ between the electric field correcting electrodes (see FIG. 16) is kept at 9.0 mm. As L3/L4 decreases, the coma aberration approaches 0. When the distance L3 is decreased, although the coma aberration occurring in the third grid G3 can be alleviated, the distance L4 increases. Therefore, the coma aberration occurring in the fourth grid G4 is supposed to increase. However, as L3/L4 is smaller, the coma aberration of the entire main lens decreases. This is because, on a low voltage side (third grid G3 side) of the main lens, the speed of an electron beam is lower than that on a high voltage side fourth grid G4 side), so that the low voltage side of the main lens is likely to be influenced by a lens aberration. Thus, in order to suppress the coma aberration of the entire main lens, it is effective to decrease the coma aberration on a low voltage side. Decreasing L3/L4 is one procedure for decreasing the coma aberration on a low voltage side.

However, in the case where the distances L3, L4 from the end faces of the peripheral electrodes 33, 34 to the electric field correcting electrodes 23, 24 satisfy L3/L4<1.0, the following problem arises: as shown in FIG. 21, in the center portion of the phosphor screen 3, the distance A from the center beam center path (electron gun center axis) 63 to the side beam center path 60 becomes large. The reason for this will be described below. FIG. 22 is an enlarged view of a main lens part when the distances L3, L4 satisfy L3/L4<1.0. As shown in FIG. 22, the electric field 50 penetrates more on the fourth grid G4 side. The fourth grid G4 has a function of diverging the electron beams outward. Therefore, when the electric field 50 penetrates more on the fourth grid side, a force in a direction away from the electron gun center axis 63 is exerted on the side beams 6R, 6B. Consequently, as shown in FIG. 21, in the center portion of the phosphor screen, the distance A from the electron gun center axis 63 to the side beam center path 60 increases. When the distance A increases, three electron beams corresponding to R (red), G (green), and B (blue) cannot be converged at one point, so that convergence is degraded. At present, the allowable upper limit value of the correctable distance A is about 2 mm. As shown in FIG. 20, when L3/L4=1.0, the coma aberration of about 0.3 mm occurs. In order to reduce this coma aberration by about half, L3/L4=0.5 must be satisfied. However, at this time, as shown in FIG. 21, the distance A between the center beam center path 63 and the side beam center path 60 in the center portion of the phosphor screen becomes about 10 mm, which makes it difficult to correct convergence.

As described above, according to the procedure of III, there is a problem that the reduction in a coma aberration and the securing of convergence cannot be achieved together.

As described above, by forming an electric field superimposing type main lens, although the aperture of a lens can be enlarged, the coma aberration of a side beam occurs. When an attempt is made so as to eliminate this coma aberration, various new problems occur as described above. Thus, practically, the aperture of a lens cannot be enlarged sufficiently. The aperture of a lens greatly influences the dimension of a beam spot on the phosphor screen. Therefore, if the aperture of a lens cannot be enlarged, it is difficult to shorten the dimension of a beam spot on the phosphor screen, and as a result, it is difficult to enhance the resolution of a color cathode ray tube.

### SUMMARY OF THE INVENTION

Therefore, with the foregoing in mind, it is an object of the present invention to provide an electron gun forming an electric field superimposing type main lens, in which the occurrence of a coma aberration of a side beam and the degradation of convergence can be suppressed, and the dimension of a beam spot on a phosphor screen can be decreased. Furthermore, it is another object of the present invention to provide a color cathode ray tube with focus characteristics enhanced without degrading convergence characteristics.

An electron gun for a color cathode ray tube of the present invention includes an electron beam generating part for generating three electron beams composed of a center electron beam and a pair of side electron beams on both outer sides thereof, aligned on the same horizontal plane, and a main lens part at least including a focusing electrode and a final-stage accelerating electrode, for accelerating and focusing the three electron beams. The focusing electrode includes an electric field correcting electrode which is provided at a position retracted from an end on the final-stage accelerating electrode side of the focusing electrode and in which three electron beam passage apertures respectively corresponding to the three electron beams are formed, and a peripheral electrode in which one electron beam passage aperture common to the three electron beams is formed on a surface opposed to the final-stage accelerating electrode. The final-stage accelerating electrode includes an electric field correcting electrode which is provided at a position retracted from an end on the focusing electrode side of the final-stage accelerating electrode and in which three electron beam passage apertures respectively corresponding to the three electron beams are formed, and a peripheral electrode in which one electron beam passage aperture common to the three electron beams is formed on a surface opposed to the focusing electrode.

Assuming that a distance from an end on the final-stage accelerating electrode side of the peripheral electrode provided in the focusing electrode to the electric field correcting electrode provided in the focusing electrode is L1, and a distance from an end on the focusing electrode side of the peripheral electrode provided in the final-stage accelerating electrode to the electric field correcting electrode provided in the final-stage accelerating electrode is L2, a relationship: L1<L2 is satisfied.

Assuming that a horizontal dimension of the electron beam passage aperture formed in the peripheral electrode provided in the focusing electrode is H1, and a vertical dimension thereof is V1, and assuming that a horizontal dimension of the electron beam passage aperture formed in the peripheral electrode provided in the final-stage accelerating electrode is H2, and a vertical dimension thereof is V2, a relationship: V1/H1>V2/H2 is satisfied.

The color cathode ray tube of the present invention includes the above-mentioned electron gun of the present invention.

### BRIEF DESCRIPTION OF THE DRAWINGS

FIG. 1 is a horizontal cross-sectional view showing a schematic configuration of an electron gun according to one embodiment of the present invention.

FIG. 2A is a front view of a peripheral electrode on a fourth grid side provided in a third grid of the electron gun according to one embodiment of the present invention, and FIG. 2B is a front view of a peripheral electrode on a third grid side provided in a fourth grid of the electron gun according to one embodiment of the present invention.

FIG. 3 is an electric field diagram on the periphery of a main lens of the electron gun according to one embodiment of the present invention using an electric field superimposing type main lens.

FIG. 4 is a diagram showing a relationship between a vertical dimension V2 of an electron beam passage aperture formed in the peripheral electrode of the fourth grid on the third grid side and the coma aberration of a side beam, in an electron gun according to one example of the present invention using an electric field superimposing type main lens.

FIG. 5 is a diagram showing a relationship between the vertical dimension V2 of the electron beam passage aperture formed in the peripheral electrode of the fourth grid on the third grid side and an arrival position on a phosphor screen of a side beam, in the electron gun according to one example of the present invention using an electric field superimposing type main lens.

FIG. 6 is a diagram showing a relationship between a horizontal dimension H1 of the electron beam passage aperture formed in the peripheral electrode of the third grid on the fourth grid side and the coma aberration of a side beam, in the electron gun according to one example of the present invention using an electric field superimposing type main lens.

FIG. 7 is a diagram showing a relationship between the horizontal dimension H1 of the electron beam passage aperture formed in the peripheral electrode of the third grid on the fourth grid side and the arrival position on the phosphor screen of a side beam, in the electron gun according to one example of the present invention using an electric field superimposing type main lens.

FIG. 8A is a front view of an electric field correcting electrode of a third grid in an electron gun according to another embodiment of the present invention using an electric field superimposing type main lens, and FIG. 8B is a front view of the electric field correcting electrode of a fourth grid in an electron gun according to another embodiment of the present invention using a electric field superimposing type main lens.

FIG. 9 is a view showing paths of a side beam incident upon the electric field superimposing type main lens in the electron gun according to one embodiment of the present invention.

FIG. 10 is a cross-sectional view showing a schematic configuration of an example of a color cathode ray tube apparatus.

FIG. 11 is a view showing beam spot shapes on a phosphor screen in a conventional color cathode ray tube apparatus.

FIG. 12 is a horizontal cross-sectional view showing a schematic configuration of a conventional general bipotential electron gun.

FIG. 13 is a horizontal cross-sectional view showing a schematic configuration of an electron gun using a conventional electric field superimposing type main lens.

FIG. 14 is an end view of a peripheral electrode forming a main lens in the electron gun using the conventional electric field superimposing type main lens.

FIG. 15 is a front view of an electric field correcting electrode in the electron gun using the conventional electric field superimposing type main lens.

FIG. 16 is a view showing paths of a side beam incident upon the conventional electric field superimposing type main lens.

FIG. 17 shows a relationship between the center position of a side beam passage aperture of an electric field correcting electrode and the coma aberration of a side beam, in the electron gun using the conventional electric field superimposing type main lens.

FIG. 18 is a front view of an electric field correcting electrode for correcting a coma aberration, in the electron gun using the conventional electric field superimposing type main lens.

FIG. 19 is a front view of an electric field correcting electrode in which the dimension of a side beam passage aperture is enlarged so as to correct a coma aberration, in the electron gun using the conventional electric field superimposing type main lens.

FIG. 20 shows a relationship between the attachment position of the electric field correcting electrode and the coma aberration of a side beam, in the electron gun using the conventional electric field superimposing type main lens.

FIG. 21 shows a relationship between the attachment position of the electric field correcting electrode and the arrival position on a phosphor screen of a side beam, in the electron gun using the conventional electric field superimposing type main lens.

FIG. 22 is an electric field view in the case where the distance from an end on the fourth grid side of the third grid to the electric field correcting electrode is shorter than the distance from an end on the third grid side of the fourth grid to the electric field correcting electrode, in the electron gun using the conventional electric field superimposing type main lens.

### DETAILED DESCRIPTION OF THE INVENTION

According to the present invention, even when the aperture of a main lens is enlarged using an electric field superimposing type lens, the coma aberration of a side beam can be suppressed without shortening the horizontal dimension of three electron beam passage apertures formed in an electric field correcting electrode, and a side beam is allowed to arrive at a screen at a position where convergence can be corrected. Thus, the dimension of a beam spot on a screen can be shortened without degrading convergence characteristics.

Hereinafter, the present invention will be described in detail by way of one example.

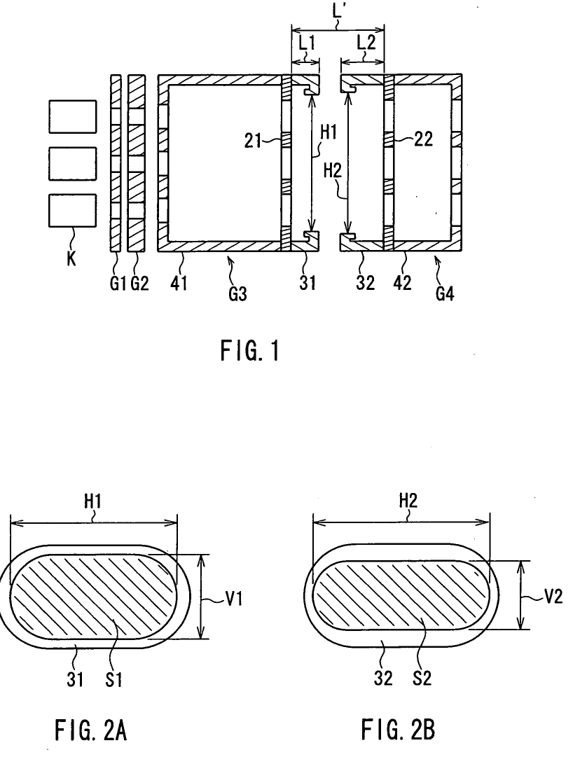

FIG. 1 shows an in-line type electron gun according to one embodiment of the present invention, which emits three electron beams composed of a center beam and a pair of side beams on both outer sides thereof, aligned on the same horizontal plane. The electron gun includes three cathodes K arranged in a line in a horizontal direction, three heaters (not shown) heating the cathodes K separately, and a first grid G1, a second grid G2, a third grid G3, and a fourth grid G4 arranged successively from the cathodes K side, and these components are fixed integrally with a pair of insulating supports (not shown).

The first grid G1 has a plate shape, and on a plate surface, three electron beam passage apertures in a substantially circular shape are formed in a straight line in the horizontal direction so as to correspond to the above three cathodes K.

The second grid G2 also has a plate shape, and on a plate surface, three electron beam passage apertures in a substantially circular shape are formed in a straight line in the horizontal direction so as to correspond to the above three cathodes K.

The third grid (focusing electrode) G3 includes a tubular electrode 41 which is placed on the second grid G2 side and in which three electron beam passage apertures in a vertically oriented shape are formed in a straight line in the horizontal direction on a surface opposed to the second grid G2, and a tubular peripheral electrode 31 which is placed on the fourth grid G4 side and in which one electron beam passage aperture common to three electron beams is formed on a surface opposed to the fourth gird G4. As shown in FIG. 2A, the electron beam passage aperture on an end face on the fourth grid G4 side of the peripheral electrode 31 is in a track field shape with a horizontal dimension H1 of 19.2 mm and a vertical dimension V1 of 9.0 mm. Furthermore, the third grid G3 includes an electric field correcting electrode 21 at a position retracted by a distance L1 of 3 mm from an end on the fourth grid G4 side of the peripheral electrode 31.

The electric field correcting electrode 21 is in a plate shape, and in the same way as in the conventional electric field correcting electrode 23 shown in FIG. 15, three electron beam passage apertures in a substantially circular shape respectively corresponding to the three electron beams are provided in a straight line in the horizontal direction. The dimension of the three electron beam passage apertures is Φ4.8 mm, and a distance sg between the center of a center beam passage aperture and the center of a side beam passage aperture is 5.7 mm.

The fourth grid (final-stage accelerating electrode) G4 includes a tubular peripheral electrode 32 which is placed on the third grid G3 side and in which one electron beam passage aperture common to the three electron beams is formed on a surface opposed to the third grid G3, and a tubular electrode 42 which is placed on a screen side and in which three electron beam passage apertures in a substantially circular shape are formed in a straight line in the horizontal direction on a surface opposed to a screen. As shown in FIG. 2B, the electron beam passage aperture on an end face on the third grid G3 side of the peripheral electrode 32 is in a track field shape with a horizontal dimension H2 of 19.2 mm and a vertical dimension V2 of 7.5 mm. Furthermore, the fourth grid G4 includes an electric field correcting electrode 22 at a position retracted by a distance L2 of 5 mm from an end on the third grid G3 side of the peripheral electrode 32. The electric field correcting electrode 22 has the same shape as that of the electric field correcting electrode 21 placed in the third grid G3.

In this electron gun, the cathodes K are supplied with a voltage of 50 to 200 V, the first grid G1 is grounded, and the second grid G2 is supplied with a voltage of about 800 V. The third grid is supplied with a voltage Vfl of about 8.4 kV, which is at a relatively intermediate level. The fourth grid G4 is supplied with a voltage Eb of about 30 kV, which is at a relatively high level.

This electron gun is applied to an in-line type color cathode ray tube, and the above-mentioned voltage is supplied to each electrode. Accordingly, a tripolar part (electron beam generating part) generating three electron beams composed of a center beam and a pair of side beams aligned in an in-line shape on the same horizontal plane is constituted by the cathodes K, the first grid G1, and the second grid G2. A pre-focus lens part preliminarily focusing the three electron beams released from the tripolar part is formed between the second grid G2 and the third grid G3, and a main lens part accelerating the three preliminarily focused electron beams and focusing them on the phosphor screen is constituted by the third grid G3 and the fourth grid G4.

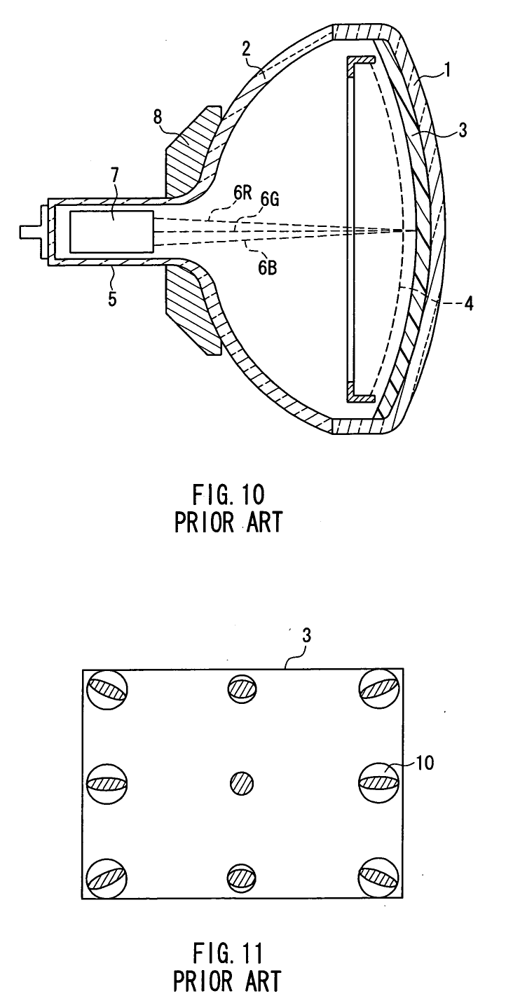

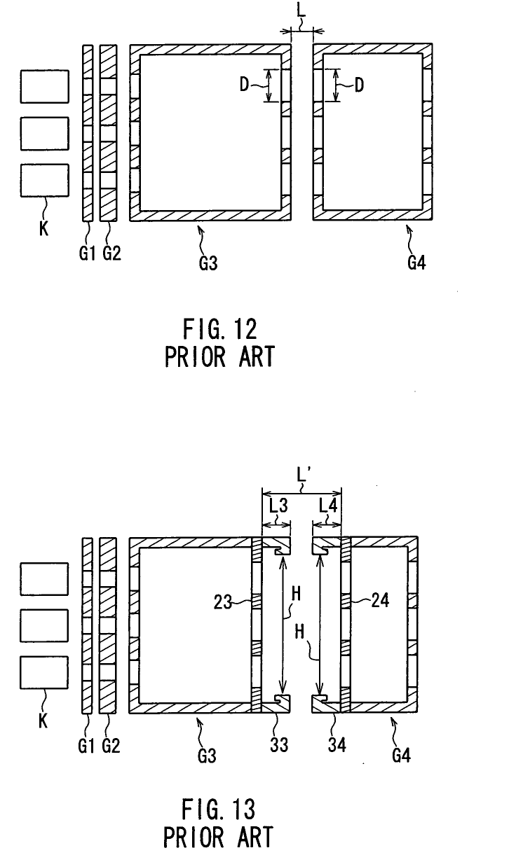

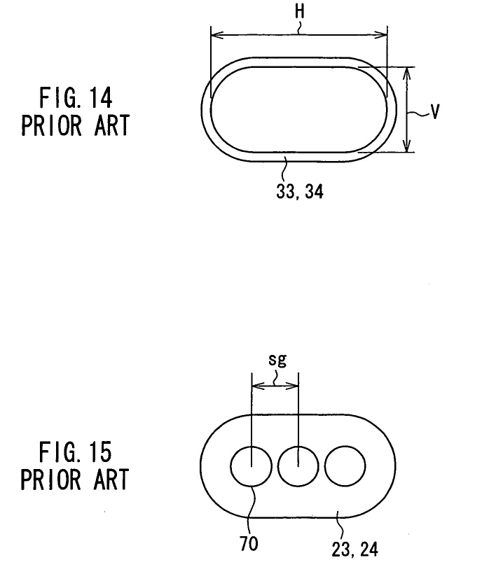

There is no particular limit to a color cathode ray tube in which the electron gun according to the present invention can be mounted, and for example, a known color cathode ray tube shown in FIG. 10 may be used.

Next, the effect of the electron gun of the present invention will be described below.

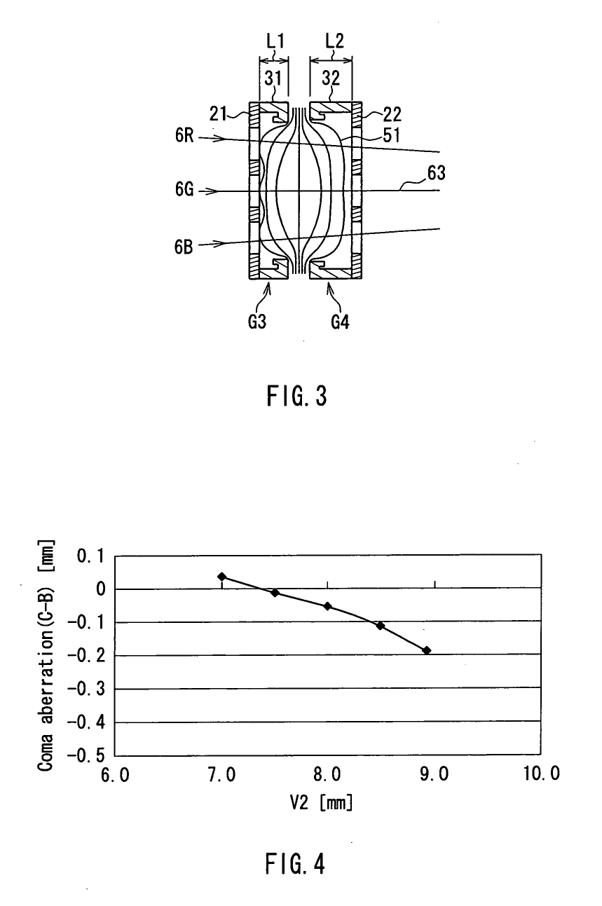

FIG. 3 is an enlarged cross-sectional view on the periphery of a main lens part of the electron gun. In the present example, a distance L1 from an end on the fourth grid G4 side of the peripheral electrode 31 of the third grid G3 to the electric field correcting electrode 21 is 3 mm, and a distance L2 from an end on the third grid G3 side of the peripheral electrode 32 of the fourth grid G4 to the electric field correcting electrode 22 is 5 mm, with L1<L2 being satisfied. Thus, an electric field 51 is likely to penetrate inside the fourth grid G4 in this state.

However, the vertical dimension V1 of the electron beam passage aperture on the end face on the fourth grid G4 side of the peripheral electrode 31 placed in the third grid G3 is 9.0 mm, and the vertical dimension V2 of the electron beam passage aperture on the end face on the third grid G3 side of the peripheral electrode 32 placed in the fourth grid G4 is 7.5 mm, with V1>V2 being satisfied. Because of this, in the fourth grid G4, a quadrupole lens function becomes strong, in which the divergence in the vertical direction is stronger than that in the horizontal direction. More specifically, by decreasing the vertical dimension V2 of the electron beam passage aperture of the peripheral electrode 32 of the fourth grid G4, the diverging force in the horizontal direction in the fourth grid G4 becomes weak. Consequently, the function of separating a side beam from a center beam in the fourth grid G4 becomes weak.

Furthermore, assuming that an aperture area of the electron beam passage aperture on the end face on the fourth grid G4 side of the peripheral electrode 31 of the third grid G3 is S1 (see FIG. 2A), and an aperture area of the electron beam passage aperture on the end face on the third grid G3 side of the peripheral electrode 32 of the fourth grid G4 is S2 (see FIG. 2B), S1>S2 is satisfied. Because of this, the electric field 51 becomes unlikely to penetrate inside the fourth grid G4, and the diverging force in the horizontal direction in the fourth grid G4 decreases further. Consequently, the function of separating a side beam from a center beam in the fourth grid G4 becomes weaker.

FIG. 4 shows results obtained by calculating a relationship between the vertical dimension V2 of the electron beam passage aperture formed in the peripheral electrode 32 of the fourth grid G4 and the coma aberration, in the above example.

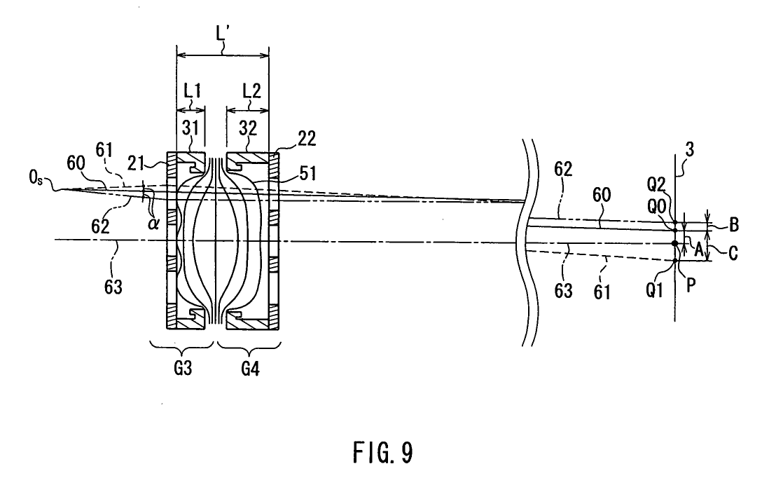

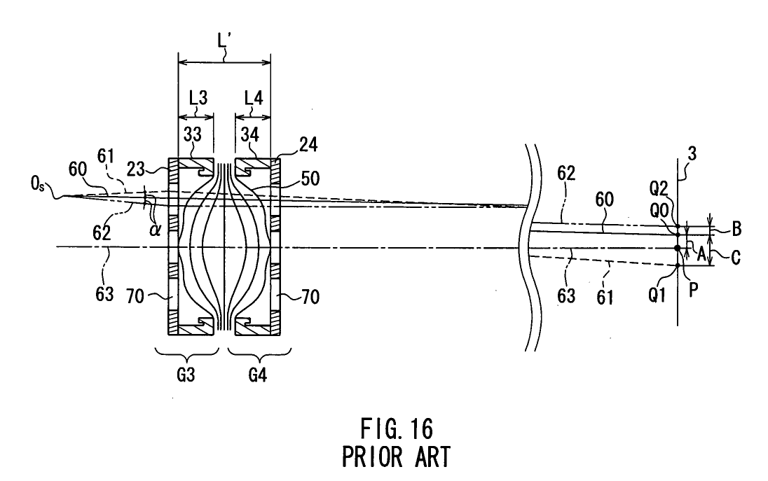

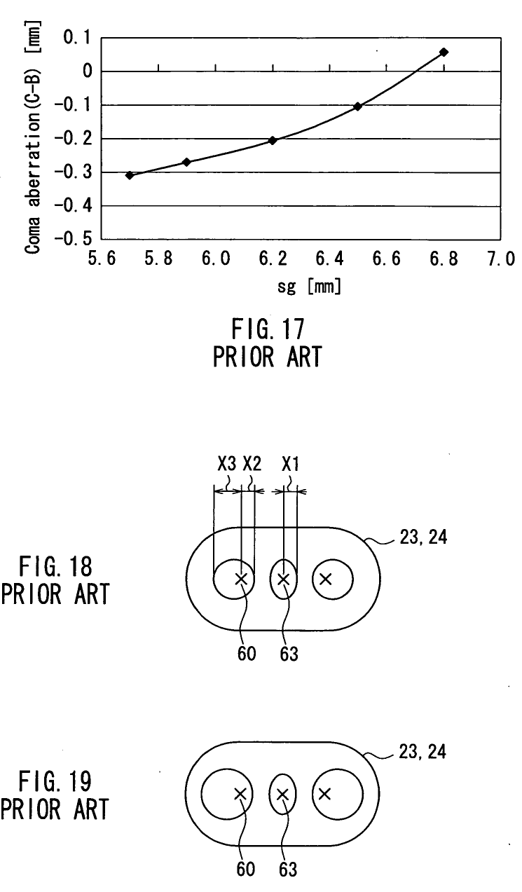

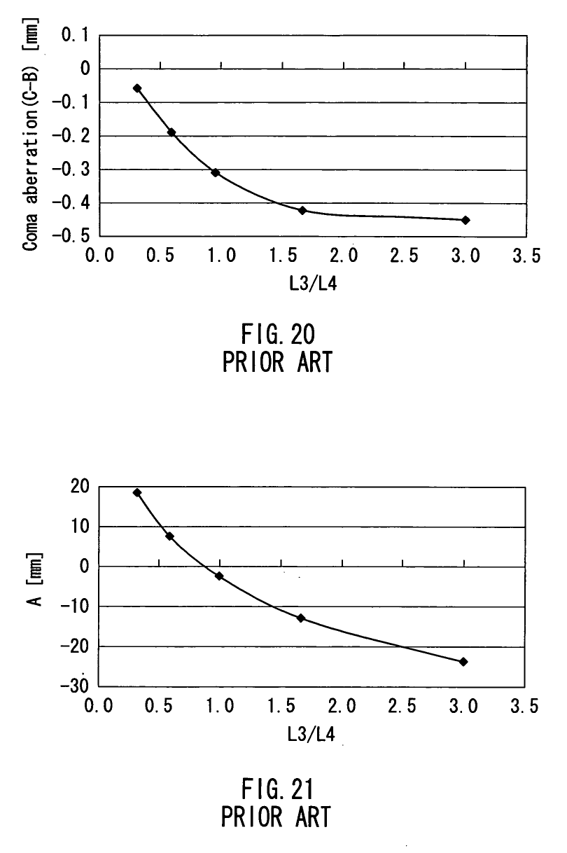

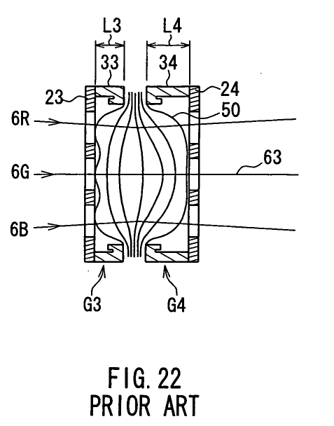

In order to obtain the relationship in FIG. 4, the path of a side beam emitted from a point Os as shown in FIG. 9 was calculated. A position of the point Os, an output angle of a side beam center path 60 with respect to an electron gun center axis 63, and an output angle α of a side beam outside path 61 and a side beam inside path 62 with respect to the side beam center path 60 were set to be the same as those in the conventional example shown in FIG. 16. Furthermore, in the same way as in the conventional example, in the center portion of the phosphor screen 3, an arrival point of the center beam center path (electron gun center axis) 63 is P, an arrival point of the side beam center path 60 is Q0, an arrival point of a side beam outside path 61 is Q1, and an arrival point of a side beam inside path 62 is Q2, and the distance between the points P and Q0 is A, the distance between the points Q0 and Q1 is C, and the distance between the points Q0 and Q2 is B.

It is understood from FIG. 4 that, when the vertical dimension V2 of the electron beam passage aperture of the peripheral electrode 32 of the fourth grid G4 is shortened from 9.0 mm, which is the same dimension as the vertical dimension V1 of the electron beam passage aperture of the peripheral electrode 31 of the third grid G3, a coma aberration (C-B) also is gradually reduced, and substantially eliminated in the vicinity of V2=7.5 mm.

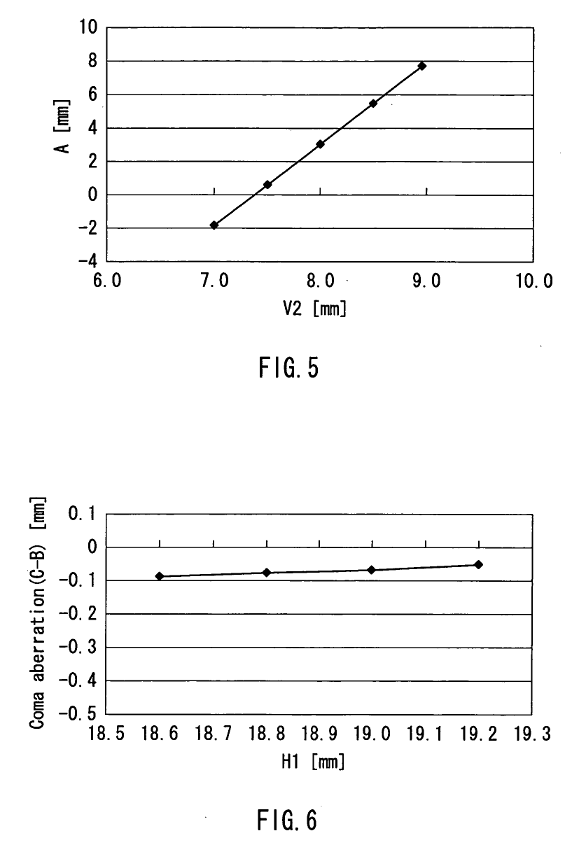

Furthermore, as shown in FIG. 5, the distance A between the side beam center path 60 and the electron gun center axis (center beam center path) 63 in the center portion of the phosphor screen also is gradually shortened, when the vertical dimension V2 of the electron beam passage aperture of the peripheral electrode 32 is shortened from 9.0 mm, and becomes substantially 0 mm in the vicinity of V2=7.5 mm. That is, convergence is enhanced.

Thus, by optimizing the vertical dimension V2 of the electron beam passage aperture of the peripheral electrode 32, the coma aberration and the convergence in the center portion of the phosphor screen can be made appropriate.

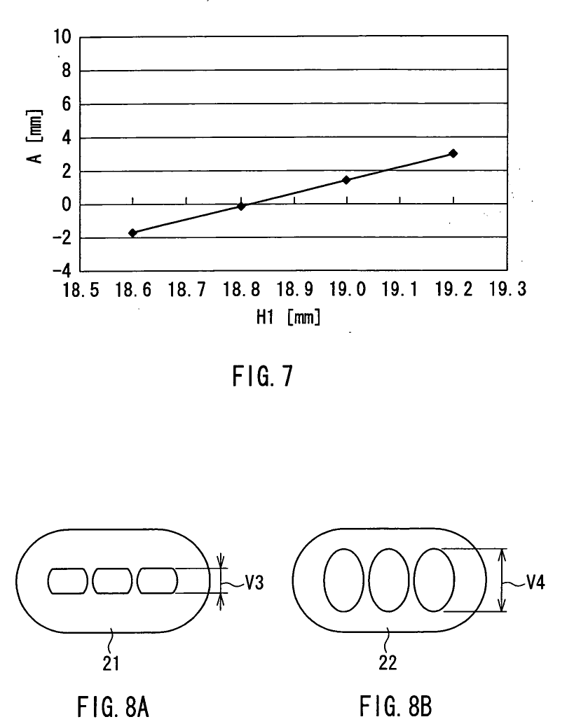

The effect that is substantially the same as the above also is obtained in the case where a horizontal dimension H1 of the electron beam passage aperture of the peripheral electrode 31 placed in the third grid G3 and a horizontal dimension H2 of the electron beam passage aperture of the peripheral electrode 32 placed in the fourth grid G4 satisfy H1<H2. FIG. 6 shows a relationship between the horizontal dimension H1 and the coma aberration (C-B) when H2=19.2 mm, V2=8.0 mm, and V1=9.0 mm, under the above conditions. FIG. 7 shows a relationship between the horizontal dimension H1, and the distance A between the side beam center path 60 and the electron gun center axis (center beam center path) 63 in the center portion of the phosphor screen, under the same conditions as those in FIG. 6. As shown in FIG. 6, when the horizontal dimension H1 of the electron beam passage aperture of the peripheral electrode 31 of the third grid G3 is shortened from 19.2 mm, which is the same dimension as the horizontal dimension H2 of the electron beam passage aperture of the peripheral electrode 32 of the fourth grid G4, the coma aberration is degraded; however, the degradation degree is very small, which is at a practical level. On the other hand, as shown in FIG. 7, as the horizontal dimension H1 of the peripheral electrode 31 of the third grid G3 is shortened from 19.2 mm, which is the same dimension as the horizontal dimension H2 of the peripheral electrode 32 of the fourth grid G4, the distance A gradually approaches 0 mm, and becomes 0 mm in the vicinity of H1=18.8 mm.

As described above, it is important to optimize the relationship between V1 and V2, and/or the relationship between H1 and H2. More specifically, it is preferable to satisfy V1>V2 and/or H1<H2. That is, it is preferable to satisfy V1/H1>V2/H2. Because of this, the coma aberration of a side beam can be reduced without shortening the horizontal dimension of the electron beam passage apertures formed in the electric field correcting electrodes 21, 22. Also, on the phosphor screen, a side beam arrives at a position close to a center beam to such a degree that convergence can be corrected, so that the degradation of convergence also can be suppressed.

In the above example, the shape of the electron beam passage aperture of the peripheral electrode 32 of the fourth grid is set in a horizontally oriented shape with a relatively small ratio V2/H2. Therefore, an astigmatism occurs in each electron beam in the horizontal and vertical directions.

This astigmatism can be reduced by setting the shape of the electron beam passage apertures of the electric field correcting electrode 21 in the third grid G3 in a horizontally oriented shape, as shown in FIG. 8A. As described above, in order to reduce the influence of a deflection aberration of a magnetic field generated by a deflection yoke, generally, it is preferable to allow an electron beam with a cross-section in a horizontally oriented shape to be incident upon a main lens. Therefore, there is no problem in setting the shape of the electron beam passage apertures of the electric field correcting electrode 21 in a horizontally oriented shape.

Furthermore, the above-mentioned astigmatism also can be reduced by setting the shape of the electron beam passage apertures of the electric field correcting electrode 22 in the fourth grid G4 in a vertically oriented shape, as shown in FIG. 8B.

Thus, assuming that the vertical dimension of the electron beam passage apertures of the electric field correcting electrode 21 in the third grid G3 is V3, and the vertical dimension of the electron beam passage apertures of the electric field correcting electrode 22 in the fourth grid G4 is V4, by satisfying V3<V4, the above astigmatism can be reduced.

In the electron gun shown in FIG. 1, although the peripheral electrode 31 and the electrode 41 constituting the third grid G3 are connected to each other via the electric field correcting electrode 21, the present invention is not limited thereto. For example, the peripheral electrode 31 and the electrode 41 may be connected to each other directly, and the electric field correcting electrode 21 may be fixed to one inner wall surface of the peripheral electrode 31 and the electrode 41. Furthermore, although the peripheral electrode 32 and the electrode 42 constituting the fourth grid G4 are connected to each other via the electric field correcting electrode 22, the present invention is not limited thereto. For example, the peripheral electrode 32 and the electrode 42 may be connected to each other directly, and the electric field correcting electrode 22 may be fixed to one inner wall surface of the peripheral electrode 32 and the electrode 42.

In the electron gun for a color cathode ray tube according to the present invention, a coma aberration can be reduced while using an electric field superimposing type main lens, without shortening the horizontal dimension of three electron beam passage apertures formed in an electric field correcting electrode set in an electrode forming the main lens, and convergence characteristics are substantially comparable to those of a conventional electron gun. Thus, the electron gun of the present invention can be applied widely for a color cathode ray tube with excellent focus characteristics, in which a lens with a large aperture that is a feature of the electric field superimposing type main lens is taken full advantage of.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An electron gun for a color cathode ray tube, comprising:
an electron beam generating part for generating three electron beams composed of a center electron beam and a pair of side electron beams on both outer sides thereof, aligned on a same horizontal plane; and
a main lens part at least including a focusing electrode and a final-stage accelerating electrode, for accelerating and focusing the three electron beams,
wherein the focusing electrode includes an electric field correcting electrode which is provided at a position retracted from an end on the final-stage accelerating electrode side of the focusing electrode and in which three electron beam passage apertures respectively corresponding to the three electron beams are formed, and a peripheral electrode in which one electron beam passage aperture common to the three electron beams is formed on a surface opposed to the final-stage accelerating electrode,
wherein the final-stage accelerating electrode includes an electric field correcting electrode which is provided at a position retracted from an end on the focusing electrode side of the final-stage accelerating electrode and in which three electron beam passage apertures respectively corresponding to the three electron beams are formed, and a peripheral electrode in which one electron beam passage aperture common to the three electron beams is formed on a surface opposed to the focusing electrode,
assuming that a distance from an end on the final-stage accelerating electrode side of the peripheral electrode provided in the focusing electrode to the electric field correcting electrode provided in the focusing electrode is L1, and a distance from an end on the focusing electrode side of the peripheral electrode provided in the final-stage accelerating electrode to the electric field correcting electrode provided in the final-stage accelerating electrode is L2, a relationship: L1<L2 is satisfied, and
assuming that a horizontal dimension of the electron beam passage aperture formed in the peripheral electrode provided in the focusing electrode is H1, and a vertical dimension thereof is V1, and assuming that a horizontal dimension of the electron beam passage aperture formed in the peripheral electrode provided in the final-stage accelerating electrode is H2, and a vertical dimension thereof is V2, a relationship: V1/H1>V2/H2 is satisfied.

2. The electron gun for a color cathode ray tube according to claim 1, wherein, assuming that an aperture area of the electron beam passage aperture formed in the peripheral electrode provided in the focusing electrode is S1, and an aperture area of the electron beam passage aperture formed in the peripheral electrode provided in the final-stage accelerating electrode is S2, a relationship: S1>S2 is satisfied.

3. The electron gun for a color cathode ray tube according to claim 1, wherein a relationship: H1<H2 is satisfied.

4. The electron gun for a color cathode ray tube according to claim 1, wherein, assuming that a vertical dimension of the three electron beam passage apertures formed in the electric field correcting electrode provided in the focusing electrode is V3, and a vertical dimension of the three electron beam passage apertures formed in the electric field correcting electrode provided in the final-stage accelerating electrode is V4, a relationship: V3<V4 is satisfied.

5. A color cathode ray tube comprising the electron gun of claim 1.
